(19) United States
(12) Patent Application Publication
(10) Pub. No.: US 2025/0026568 A1
(43) Pub. Date: Jan. 23, 2025

(54) SHELF DE-STACKER

(71) Applicant: OCADO INNOVATION LIMITED, Hatfield, Hertfordshire (GB)

(72) Inventors: Oliver Frederick KIRBY, Hatfield, Hertfordshire (GB); Leslie WYNN, Hatfield, Hertfordshire (GB)

(73) Assignee: OCADO INNOVATION LIMITED, Hatfield, Hertfordshire (GB)

(21) Appl. No.: 18/716,000

(22) PCT Filed: Nov. 30, 2022
(86) PCT No.: PCT/EP2022/083805

§ 371 Date: Jun. 3, 2024

(30) Foreign Application Priority Data
Dec. 3, 2021 (GB) 2117495.8

(51) Int. Cl. B65G 1/06

(52) U.S. Cl. CPC B65G 1/06; B65G 2201/0235

(57) ABSTRACT

An automatic destacking device for loading and unloading containers from a rack, the destacking device including an unloading/loading unit including: a vertical frame having a pair of laterally spaced upright supports; a plurality of shelves vertically spaced between the upright supports, each shelf being configured to support a container thereon, wherein each shelf provides a storage level for the containers such that the shelves provide an array of vertically stacked storage levels for the containers, each shelf being vertically moveable to a different height position along the frame so as to move a container supported on the shelf up or down the storage levels.

### TECHNICAL FIELD

The present invention relates to the field of automatic destacking devices. In particular, the present invention relates to automatic destacking devices for loading and unloading containers from a rack.

### BACKGROUND

Warehouses or distribution centres for storage and retrieval of products or items can comprise automated storage and retrieval systems in which stacks of containers are arranged within a grid framework structure. The containers are stacked on top of one another to form stacks arranged in the grid framework structure and are accessed by robotic load handling devices remotely operative on tracks located on the top of the grid framework. Whilst this type of automated storage and retrieval system provides for a very dense system for storage of items, the size of the grid framework structure to store the containers requires adequate headroom above the grid framework to accommodate the robotic load handing devices, making this type of storage and retrieval system usually best suited for larger warehouses and distribution centres.

For smaller warehouses or warehouses with limited ceiling height, storage of products and items can be done in containers held on a series of racks that are accessible by transport devices that are moveable within aisles between the racks. The transport device, either manually driven or automated, travels up and down aisles between the racks and retrieves the necessary containers from the racks before transporting the containers to a handling area. The handling area may include a container receiving station (such as a pick station) and often includes a horizontal conveyor means or table on which the containers are processed/handled.

In order to increase the number containers held by the transport device, the transport device can comprise a plurality of shelves, thereby enabling it to hold and transport a container on each shelf. Once these multi-shelf transport devices arrive at the handling area the containers need to be unloaded from the transport device shelves.

It is against this background that the present invention has been devised.

### SUMMARY OF INVENTION

In a first aspect, there is provided an automatic destacking device for loading and unloading containers from a rack, the destacking device comprising an unloading/loading unit comprising:
a vertical frame comprising a pair of laterally spaced upright supports;
a plurality of shelves vertically spaced between the upright supports, each shelf being configured to support a container thereon, wherein each shelf provides a storage level for the containers such that the shelves provide an array of vertically stacked storage levels for the containers, each shelf being vertically moveable to a different height position along the frame so as to move a container supported on the shelf up or down the storage levels.

The above destacking device advantageously comprises shelves for supporting containers thereon that are vertically moveable to different height positions along the frame such that the containers supported on the shelves can be moved to different storage levels of the unloading/loading unit. The destacking device can advantageously handle and re-order containers in a space efficient manner, making the above destacking device particularly suitable for smaller warehouses or warehouses with limited space.

A shelf of the unloading/loading unit may be vertically moveable to a different height position along the frame so as to move a container supported on the shelf up or down the storage levels to and/or from a designated/predetermined storage level.

The destacking device may further comprise a horizontal transport means located at a position level with the designated/predetermined storage level, the horizontal transport means being configured to transfer containers from the designated/predetermined storage level to a transfer position on the horizontal transport means, thereby destacking the containers from the unloading/loading unit. The unloading/loading unit may further comprise a transfer means for transferring a container from the designated/predetermined level to the horizontal transport means.

By providing a destacking device that can transfer containers stacked within the device to a horizontal transport means, thereby destacking the containers for further processing, the above destacking device is able to provide a more efficient and faster throughput of containers. Furthermore, the above destacking device can be particularly suitable for warehouses that use rack storage and multi-shelf retrieval systems, including, for example, in warehouses with limited space or limited ceiling height.

The automatic destacking device may be configured to function in reverse to transfer containers from the transfer position to the designated/predetermined storage level of the unloading/loading unit.

The shelves may be vertically moveable to a different height position so as to move a container at the designated/predetermined storage level to a different storage level of the unloading/loading unit, thereby enabling stacking of containers into the unloading/loading unit.

The designated/predetermined storage level may be the lowermost level of the vertically stacked storage levels.

The horizontal transport means may comprise a conveyor means.

The automatic destacking device may further comprise a drive means for moving the shelves to different height positions along the frame.

Each self may comprise a pair of opposing horizontal support members extending inwards from the upright supports.

Each pair of support members may comprise a first support member coupled to the first upright support and a second support member coupled to the second upright support. The first upright support may provide a guide member for guiding movement of the first support members. The second upright support may provide a guide member for guiding movement of the second support members. The first support members may rotate around the first upright support in a vertical loop. The second support members may rotate around the second upright support in a vertical loop.

The drive means may be configured to move the first support members up or down the frame synchronously with the second support members, thereby keeping the first and second support members from each pair of support members oppositely facing as they move up and down the vertical frame.

Each support member may comprise a shelf portion and a support portion, wherein the support portions are configured to move laterally outwards and wherein the shelf portions are configured to move vertically relative to the support portions, thereby moving the containers up or down the storage levels.

The shelf portions may be mounted to an inner section of the upright supports. The support portions may be mounted to an outer section of the upright supports.

The destacking device may further comprise a rack unit comprising a plurality of shelves configured to support a container on each shelf. The rack unit may be located to the rear of the unloading/loading unit. The rack unit may be configured to transfer containers from the shelves of the rack unit to the shelves of the unloading/loading unit.

The shelves of the rack unit may comprise conveyor means for transferring the containers from the rack unit to the shelves of the unloading/loading unit.

The destacking device may be configured to transfer containers individually from the rack unit to the unloading/loading unit. The destacking device may be configured to transfer containers from the rack unit to the unloading/loading unit in a predetermined order. The destacking device may be configured to transfer multiple containers simultaneously from the rack unit to the unloading/loading unit. The destacking device may be configured to transfer containers from the rack unit to the vertical frame in batches.

In another aspect, there is provided an automatic destacking system for loading and unloading containers from a rack, the destacking system comprising:
at least two destacking devices as described above;
an exchange unit located between the at least two destacking devices, the exchange unit comprising a plurality of shelves configured to support a container on each shelf, the exchange unit being configured to transfer a first stack of containers to the first of the at least two destacking devices and simultaneously receive a second stack of containers from the second of the at least two destacking devices.

### BRIEF DESCRIPTION OF THE DRAWINGS

Aspects and example embodiments of the present invention will now be described with reference to the accompanying drawings.

FIGS. 1 to 10 illustrate sequential operating positions of an embodiment of automatic destacking device;

FIGS. 11 to 25 illustrate sequential operating positions of another embodiment of automatic destacking device;

FIGS. 26 to 63 illustrate sequential operating positions of another embodiment of automatic destacking device;

FIGS. 64 to 67 show schematic views of a warehouse comprising an embodiment of destacking system; and

FIGS. 68 to 71 show schematic views of a warehouse comprising another embodiment of destacking system.

### DETAILED DESCRIPTION

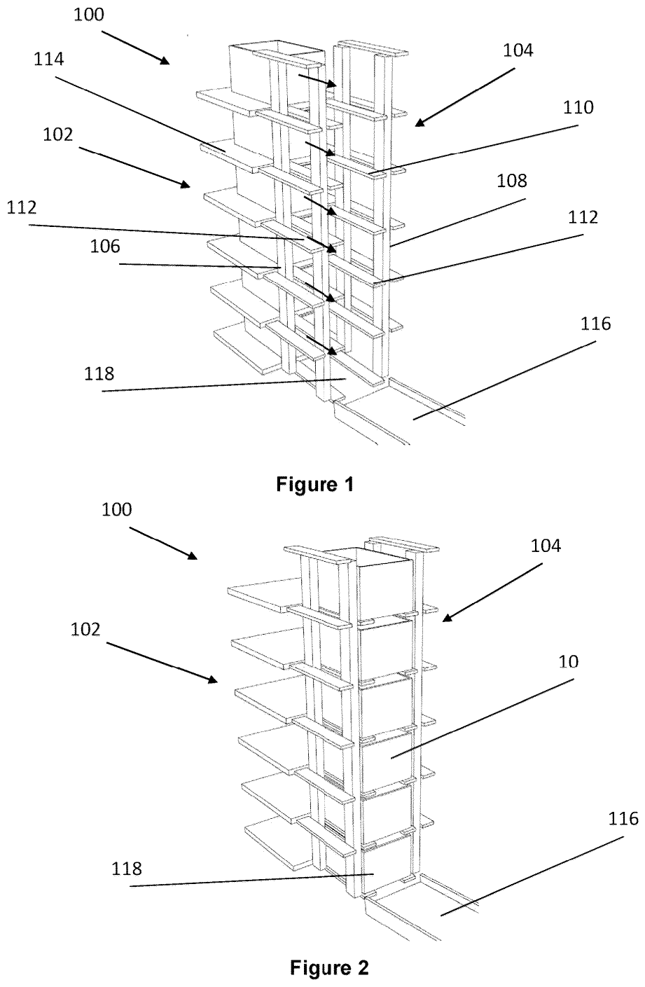

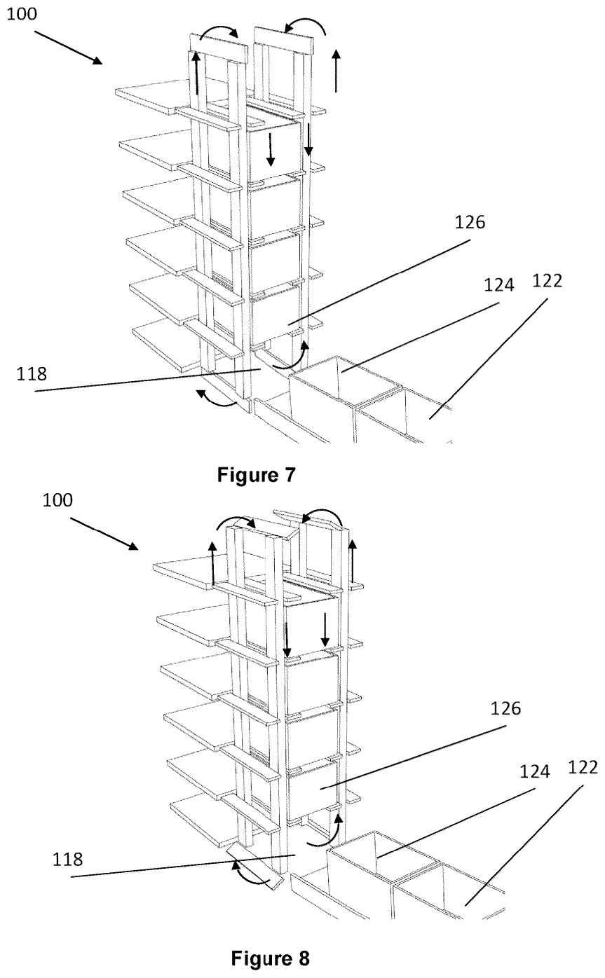

FIGS. 1 to 10 show an embodiment of automatic destacking device 100 as it moves through a sequence of movements to destack or unload containers 10 from a rack to a horizontal transport means. Turning first to FIGS. 1 and 2, the automatic destacking device 100 includes a rear portion comprising a rack unit 102 and a front portion comprising an unloading unit 104. The unloading unit 104 includes a vertical frame comprising two laterally spaced upright supports 106, 108, each upright support comprising a pair of vertical posts, and a plurality of shelves 110 vertically spaced between the upright supports 106, 108 (i.e. the shelves 110 are located in the space between the upright supports 106, 108). Each shelf 110 is configured to support a container thereon, such that each shelf 110 provides a storage level for the containers 10 (see FIG. 2). In this way, the shelves of the unloading unit 104 provide an array of vertically stacked (i.e. arranged one above another) storage levels for the containers 10. Each shelf 110 on the unloading unit 104 comprises a pair of opposing horizontal support members or brackets 112 mounted to the upright supports 106, 108 and extending inwardly from the upright supports 106, 108.

The rack unit 102 comprises a plurality of shelves 114 configured to support a container on each shelf (see FIG. 1). The rack unit 102 is immediately adjacent to the unloading unit 104 such that it can transfer the containers 10 from the rack unit 102 to the unloading unit 104. Each shelf of the rack unit 102 includes a conveyor means for moving the containers 10 supported on the shelves 114 onto shelves 110 of the unloading unit 104 (as shown by the arrows). The rack unit 102 comprises the same number of shelves 114 as storage levels on the unloading unit 104 such that each container on the rack unit 102 can be transferred onto a corresponding shelf 110 (and thus storage level) on the unloading unit 104. Each shelf 114 on the rack unit 102 is substantially level with a corresponding storage level of the unloading unit 104 so as to enable a smooth transfer of the containers 10 from the rack unit 102 to the unloading unit 104. In other embodiments, the rack unit 102 may comprise means for transferring or pushing the containers 10 onto the shelves of the unloading unit 104.

The rack unit 102 may be configured to receive containers 10 from an AGV (Automated Guided Vehicle) comprising a plurality of shelves for holding containers 10. The AGV may be of the type that can travel, e.g. horizontally across a warehouse floor.

In some embodiments, the destacking device 100 comprises only the unloading unit 104 (with no rack unit 102). The unloading unit 104 can be positioned adjacent to a separate rack unit, a rack. The unloading unit 104 may be configured to receive containers 10 directly from an AGV. The unloading unit 104 may comprise means for transferring or pulling containers 10 from the separate rack unit 102 or the AGV onto the shelves of the unloading unit 104. Alternatively, the AGV may transfer the containers directly onto the unloading unit 104. The unloading unit 104 may comprise means for transferring or pushing containers 10 from the shelves of the unloading unit 104 to the separate rack unit 102 or the AGV.

The unloading unit 104 comprises a substantially open frame with open front and rear access to each storage level. In particular, the frame of the unloading unit 104 is accessible from the rear for receiving containers 10 on each storage level. The shelves of the unloading unit 104 are distanced equally with respect to each other, with the vertical distance between each shelf being substantially equal to or slightly bigger than the height of a container.

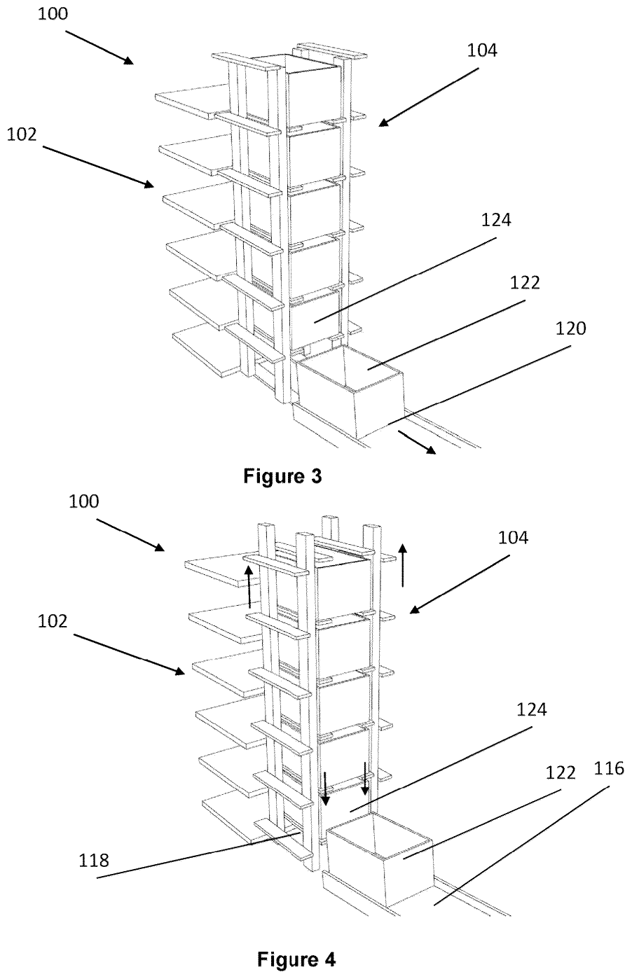

The unloading unit 104 comprises a horizontal transport means 116 located at the front of the unloading unit 104 and level with the lowermost storage level 118 of the unloading unit 104. The horizontal transport means 116 is configured to transfer a container on the lowermost storage level 118 of the unloading unit 104 to the horizontal transport means 116, i.e. a transfer position 120 on the horizontal transport means 116 (as shown in FIG. 3). As a container is held on the brackets 112 at the lowermost storage level 118 of the unloading unit 104, a portion of the lower surface of the container contacts the horizontal transport means 116 which transfers the container from the lowermost storage level 118 to the transfer position 120 on the horizontal transport means 116. The horizontal transport means 116 comprises a conveyor means (e.g. a belt conveyor, a roller conveyor etc.) for moving or pulling the container out from the lowermost storage level 118 to the transfer position 120 on the horizontal transport means 116. Thus, the horizontal transport means 116 moves a first container 122 out from the lowermost storage level 118 of the unloading unit 104 and onto the horizontal transport means 116. In other embodiments, the unloading unit 104 may comprise a transfer means for transferring a container on the lowermost storage level 118 of the unloading unit 104 to the horizontal transport means 116. For example, the brackets 112 of the unloading unit 104 may comprise a conveyor means (e.g. a belt conveyor, a roller conveyor etc.) for moving the container from the brackets 112 to the horizontal transport means 116.

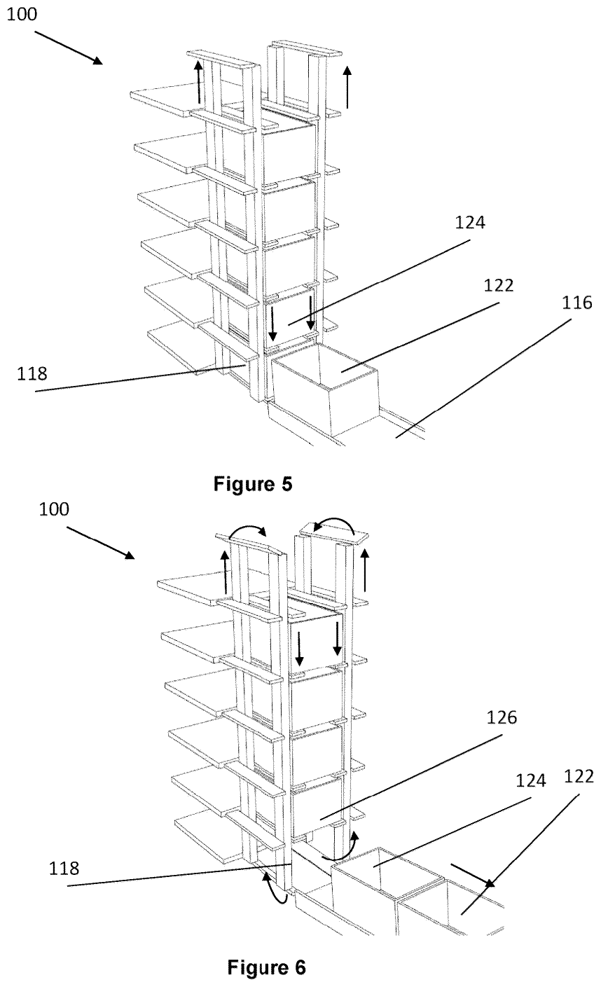

As shown in FIG. 3, once the first container 122 at the lowermost storage level 118 is removed from the unloading unit 104 by the horizontal transport means 116, the lowermost storage level 118 is left unoccupied. The brackets 112 of the unloading device are moveable vertically down the frame so as to move a second container 124 held on a second storage level (i.e. the storage level directly above the lowermost storage level 118) down to the lowermost storage level 118. Each pair of brackets 112 (or each shelf of the unloading device) moves synchronously down by one storage level thereby moving the containers 10 down a storage level as shown in FIGS. 4 and 5. As the second container 112 reaches the lowermost storage level 118 of the unloading unit 104, a portion of the lower surface of the second container contacts the horizontal transport means 116 which transfers the second container 124 out from the lowermost storage level 118 to the transfer position 120 on the horizontal transport means 116 (see FIG. 6). As the horizontal transport means 116 moves the second container 124 from the lowermost storage level 118 to the transfer position 120, the forwards movement of the horizontal transport means 116 concurrently moves the first container 122 from the transfer position 120 to a position further along the horizontal transport means 116, thereby providing space for the second container 124 to occupy the transfer position 120.

The destacking device 100 comprises a drive means for vertically moving the brackets 112 to different height positions along the frame (e.g. down the frame for moving the containers 10 down to the lowermost storage level 118, as described above).

In particular, each pair of brackets 112 comprises a first bracket coupled to the first upright support 106 (i.e. the first pair of posts) and a second bracket coupled to the second upright support 108 (i.e. the second pair of posts), where the first upright support provides a guide member for guiding movement of the first brackets 112 down the frame and the second upright support provides a guide member for guiding movement of the second brackets 112 down the frame. Each upright support comprises an endless traction means (not shown) e.g. chains or belts, that rotate (e.g. continuously) around the support in circulating vertical loops. The brackets 112 are mounted to the traction means such that the brackets 112 can rotate continuously around the supports 106, 108 in vertical loops. In particular, the brackets 112 facing towards the inside of the frame travel down the frame as the traction means rotate. As a pair of brackets 112 reaches the foot of the frame, they loop around the supports and start to move up the supports such that the brackets 112 facing outwards from the frame travel up the frame as the traction means rotate (as shown by the arrows in FIGS. 6-8).

Conversely, as a pair of brackets 112 reaches the top of the frame, they loop around the supports and move from outwards facing members to inwards facing members and start to move down the supports. The first and second brackets 112 loop around their respective supports in continuous vertical loops such that the unloading unit 104 forms a multi-level vertical loop conveyor for moving the containers 10 supported on the pairs of brackets 112 down the frame. The brackets 112 use what may be referred to as the “paternoster” principle of continuous conveyance.

The drive means rotates the traction means around the pairs of posts thereby moving the brackets 112 around the posts. In particular, the traction means rotate in a synchronous manner such that the first and second brackets from each pair of brackets 112 move synchronously up and down the frame, thereby keeping the first and second brackets from each pair oppositely facing as they move down the frame. In this way, the containers 10 held at each storage level within the frame move synchronously down all together by one storage level until a container reaches the lowermost storage level 118 and can be transferred from the unloading unit 104 to the transfer position 120 on the horizontal transport means 116.

Once the second container 124 is transferred from the lowermost storage level 118 to the transfer position 120 on the horizontal transport means 116, the lowermost storage level 118 is once more left unoccupied. The drive means resumes rotation of the traction means causing the brackets 112 on the inside of the frame to move down the frame, thereby moving a third container 126 down to the lowermost storage level 118. As the third container 126 reaches the lowermost storage level 118 of the unloading unit 104, the horizontal transport means 116 transfers the third container 126 out from the lowermost storage level 118 to the transfer position 120 on the horizontal transport means 116, as described above. The forward movement of the horizontal transport means 116 concurrently moves the first 122 and second 124 containers 10 further along the horizontal transport means 116, thereby providing space for the third container 126 to occupy the transfer position 120.

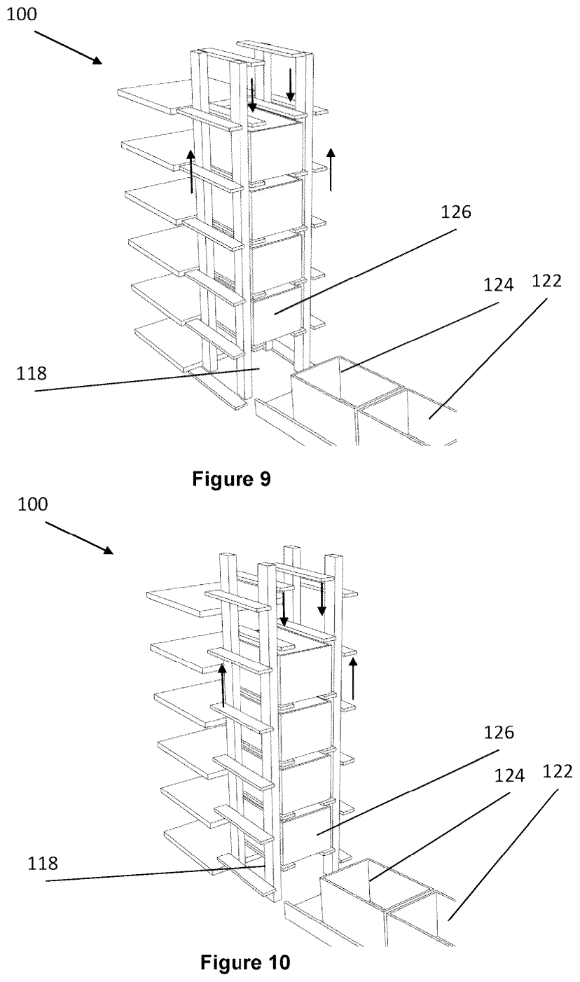

As shown by FIGS. 9 and 10, the destacking device 100 continues to loop the pairs of brackets 112 around the supports, bringing each container held on each storage level in turn to the lowermost storage level 118 to be transferred by the horizontal transfer means out from the lowermost storage level 118 and away from the unloading unit 104. The destacking device 100 continues in this way until all the containers 10 held at each storage level are unloaded from the unloading unit 104 and onto the horizontal transport means 116. The horizontal transport means 116 transfers the containers 10 away from the unloading unit 104 for further transportation or handling at a container receiving station, e.g. a pick station.

The destacking device 100 is configured to function in reverse, in order to transfer containers 10 from the horizontal transport means 116 onto the unloading unit 104 (hereinafter referred to as the unloading/loading unit), thereby stacking the containers 10 onto the vertical frame. The horizontal transport means 116 transfers a first container 128 at the transfer position 120 onto the lowermost storage level 118 of the unloading/loading unit 104. The rearwards movement of the horizontal transport means 116 to move the first container 128 onto the lowermost storage level 118 concurrently moves a second container 130 positioned further along the horizontal transport means 116 to the transfer position 120.

Once the first container 128 is on the lowermost storage level 118, the shelves or brackets 112 of the unloading/loading unit 104 are moveable vertically up the frame so as to move the first container 128 up from the lowermost storage level 118 to another storage level (e.g. the second storage level directly above the lowermost storage level 118). In particular, the drive means rotates the traction means around the supports in a reverse direction, moving the brackets 112 facing inwards from the frame (including the lowermost brackets holding the container on the lowermost storage level 118) up the frame, thereby bringing the first container to the second storage level. Thus, the lowermost storage level 118 becomes unoccupied and the horizontal transport means 116 can transfer the second container from the transfer position 120 onto the now unoccupied lowermost storage level 118. The rearwards movement of the horizontal transport means 116 to move the second container onto the lowermost storage level 118 concurrently moves a third container to the transfer position 120. The unloading/loading unit 104 and the horizontal transport means 116 can continue to function in reverse order until all the storage levels of the unloading/loading unit 104 are occupied by a container. Once the unloading/loading unit 104 is loaded with containers 10, the containers 10 can be transferred from the unloading/loading unit 104 to the shelves of the rack unit 102. The brackets 112 comprising the conveyor means may transfer the containers 10 onto the shelves of the rack unit 102. In some embodiments, the unloading/loading unit 104 may comprise alternate or additional means for pushing the containers 10 onto the shelves of the rack unit 102 (e.g. extendable or telescoping arms). In other embodiments, the rack unit 102 may comprise means for pulling the containers 10 onto the shelves.

In embodiments where the destacking device 100 comprises only the unloading/loading unit 104, the containers 10 may be transferred from the unloading/loading unit 104 directly onto a separate rack unit 102 or an AGV.

While the above embodiments describe moving the shelves (i.e. brackets 112) of the unloading/loading unit 104 by one storage level (i.e. moving the shelves up or down one storage level), the skilled person will appreciate that the destacking device 100 may move the shelves by more than one storage level at any one time, e.g. in situations where one or more storage levels do not comprise a container (i.e. not all the storage levels of the unloading/loading unit 104 are occupied by a container) or in situations where not every storage level needs to be loaded with a container. The drive means may rotate the traction means such that a pair of brackets 112 without a container can bypass the lowermost storage level 118 until a pair of brackets 112 with a container reaches the lowermost storage level 118. Similarly, when the destacking device 100 is functioning in reverse, the drive means may rotate the traction means such that the pair of brackets 112 move up the frame by more than one storage level. In this way, not every storage level must be loaded with a container.

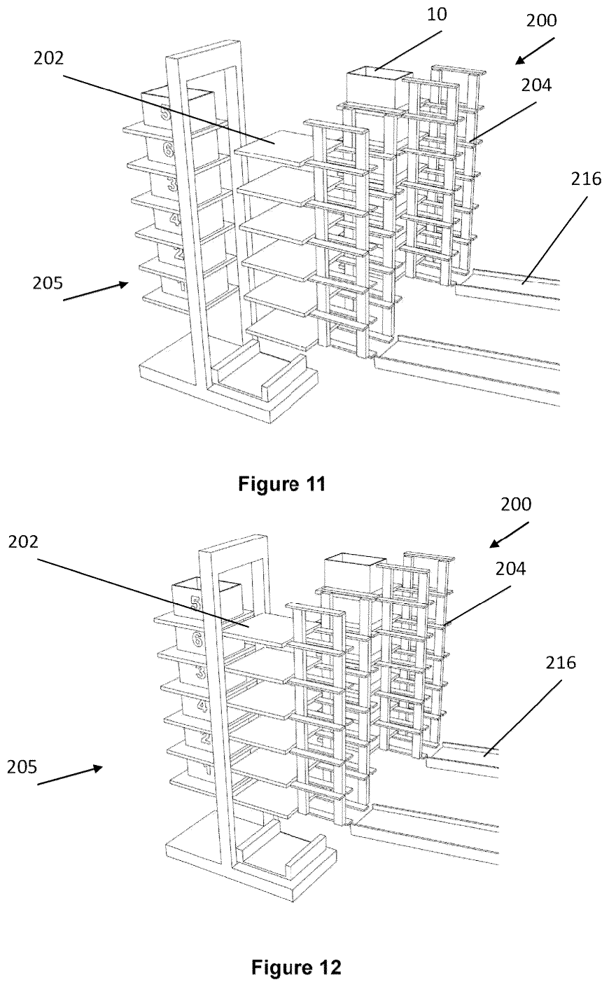

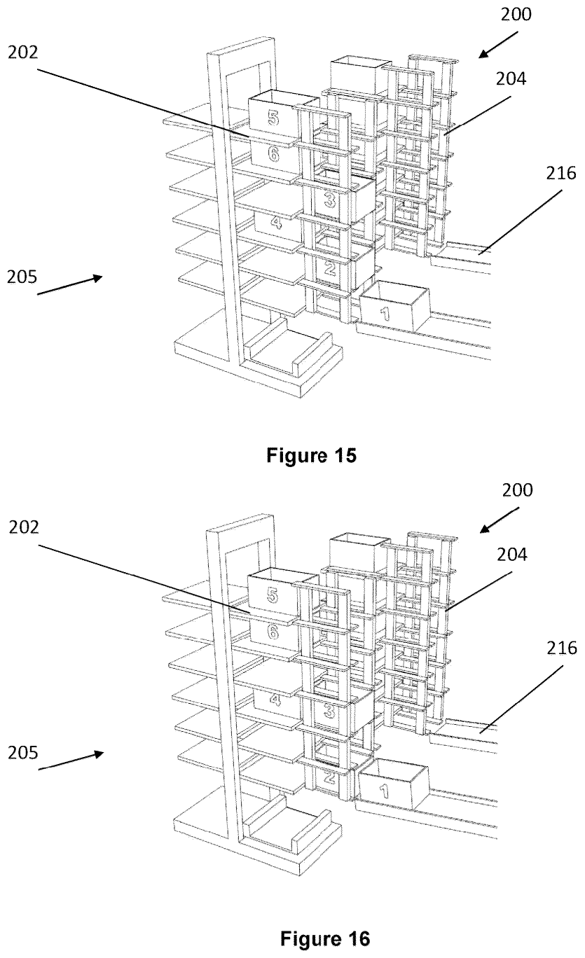

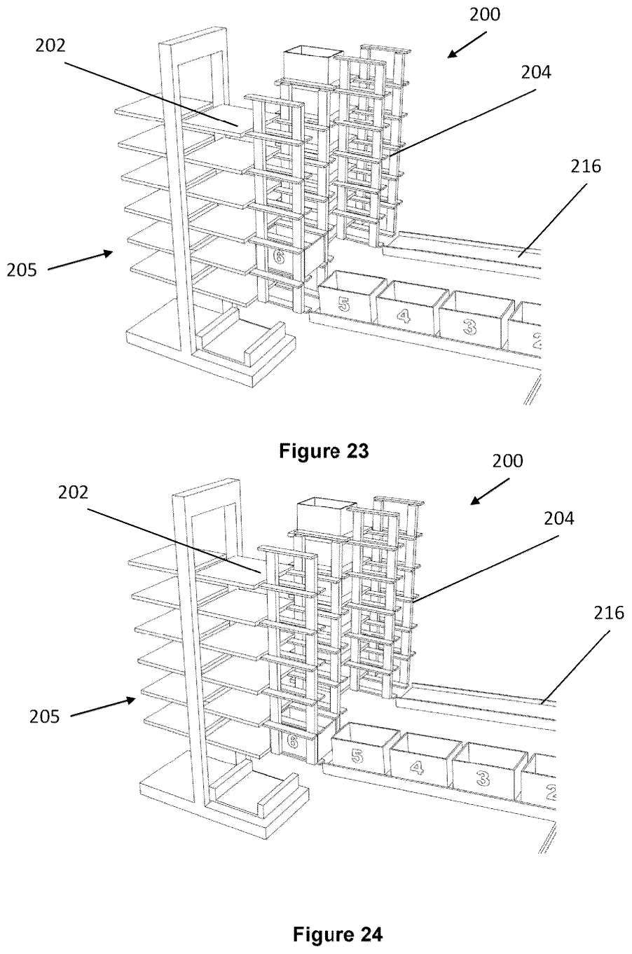

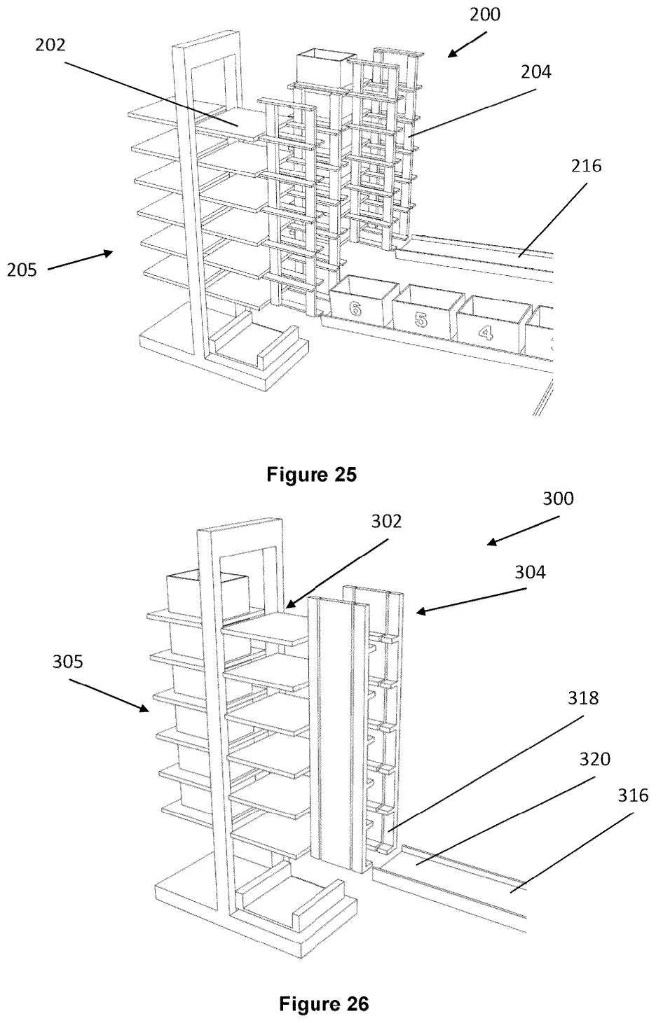

Turning now to FIGS. 11 to 25, these show another embodiment of the destacking device 200 as it moves through a sequence of movements to unload containers 10 in a selected or predetermined sequence. The destacking device 200 comprises a rack unit 202 and an unloading/loading unit 204 as described above. FIG. 11 shows an AGV (Automated Guided Vehicle) 205, comprising a plurality of shelves for holding containers 10, approaching the destacking device 200. The AGV 205 can be instructed to travel across a warehouse floor and between rows of shelves to collect one or more containers 10 from the warehouse shelves and transport them to the destacking device 200. As shown by FIG. 12, the AGV 205 is instructed to position itself directly behind the rack unit 202 of the destacking device, sufficiently adjacent the rack unit 202 such that there is a relatively small gap between the shelves of the AGV 205 and the shelves of the rack unit 202. Sensors are present on the AGV 205 and/or the destacking device 200 to determine the position of the AGV 205 relative to the destacking device 200 and to correctly position the AGV 205.

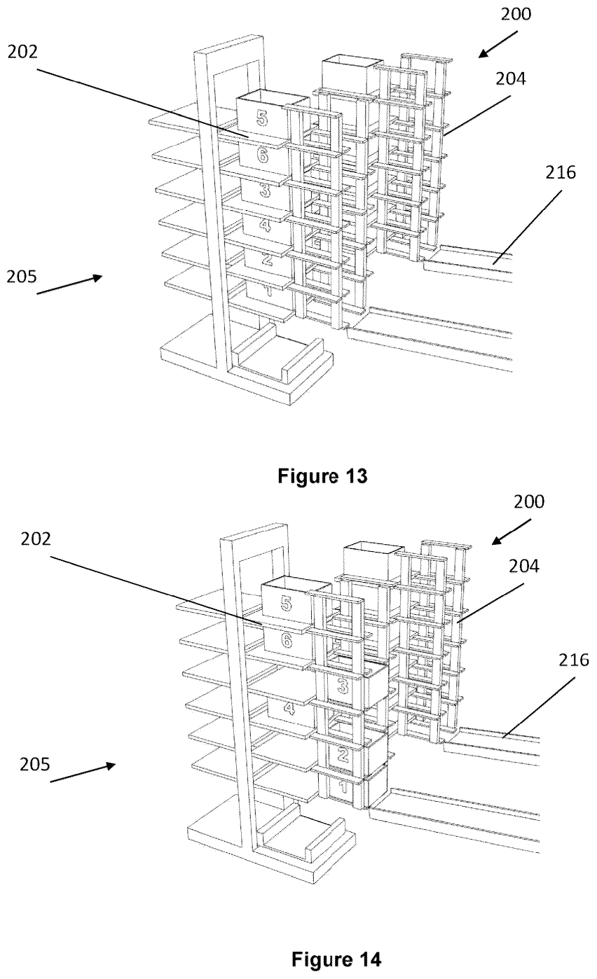

As shown by FIG. 13, the containers 10 are transferred from the AGV 205 to the rack unit 202. The rack unit 202 may comprise means for pulling the containers 10 onto the shelves of the rack unit 202 (e.g. extendable or telescoping arms). In other embodiments, the AGV 205 may comprise means for transferring the containers 10 onto the rack unit 202.

Once the containers 10 are on the rack unit 202, the rack unit 202 transfers the containers 10 onto the unloading/loading unit 204 as described above. Referring to FIG. 13, the containers 10 are stacked on the rack unit 202 out of order. The containers 10 are numbered in FIGS. 13 to 25 for illustrative purposes only to illustrate the re-ordering of the containers 10 by the destacking device 200 into a selected or predetermined order. As shown by FIG. 14, only a select number of containers are transferred from the rack unit 202 to the unloading/loading unit 204. The containers are selected according to a predetermined order in which the containers are to be unloaded from the unloading/loading unit 204 and transported away by the horizontal transport means 216. To do so, the destacking device 200 may include sensing means (e.g. barcode reader/scanner) for detecting the containers (e.g. each container's ID) held on each shelf of the rack unit 202 and a controller for determining which containers need to be transferred to the unloading/loading unit 204 according to the predetermined order. The controller is configured to instruct the rack unit 202 and/or the unloading/loading unit 204 to transfer the required containers from the rack unit 202 to the unloading/loading unit 204. The controller may determine that the containers are to be transferred from the rack unit 202 to the unloading/loading device in one or more batches. Alternatively, the destacking device 200 may include a transceiver for communicating with a centralised controller that coordinates the movement of containers between the AGV 205, the rack unit 202 and the unloading/loading unit 204, and the movement of the shelves of the unloading/loading unit 204.

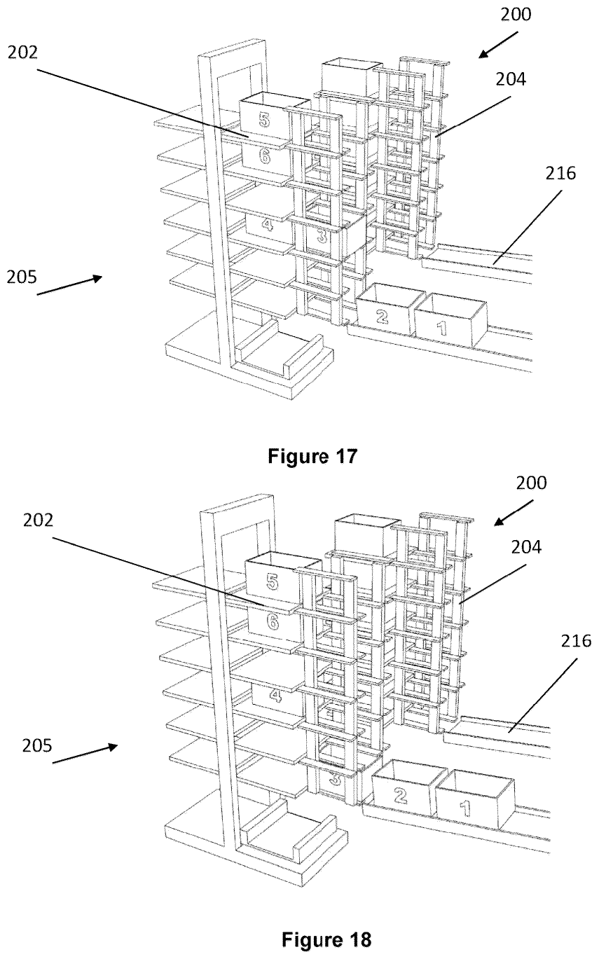

In the embodiment shown in FIGS. 11 to 25, the containers are unloaded in three batches: the first batch including containers #1, #2 and #3, the second batch including containers #4 and #5 and the third batch including container #6. As shown in FIGS. 14 to 18, containers #1, #2 and #3 are first transferred onto the unloading/loading unit 204, while containers #4, #5, #6 remain on the rack unit 202. Containers #1, #2 and #3 are then unloaded from the unloading/loading unit 204 onto the horizontal transport means 216 as described above. The first batch of selected containers are such that some of the storage levels are unoccupied (i.e. without a container), notably the storage level between containers #2 and #3 and the storage levels above container #3. As described above, the drive means can rotate the traction means such that pairs of empty brackets (i.e. brackets not supporting a container) can bypass the lowermost storage level. As shown by FIGS. 17 and 18, once container #2 is transferred from the lowermost storage level to the transfer position 220 on the horizontal transport means 216, the pair of brackets supporting container #3 move down by two storage levels so as to bring container #3 to the lowermost storage level.

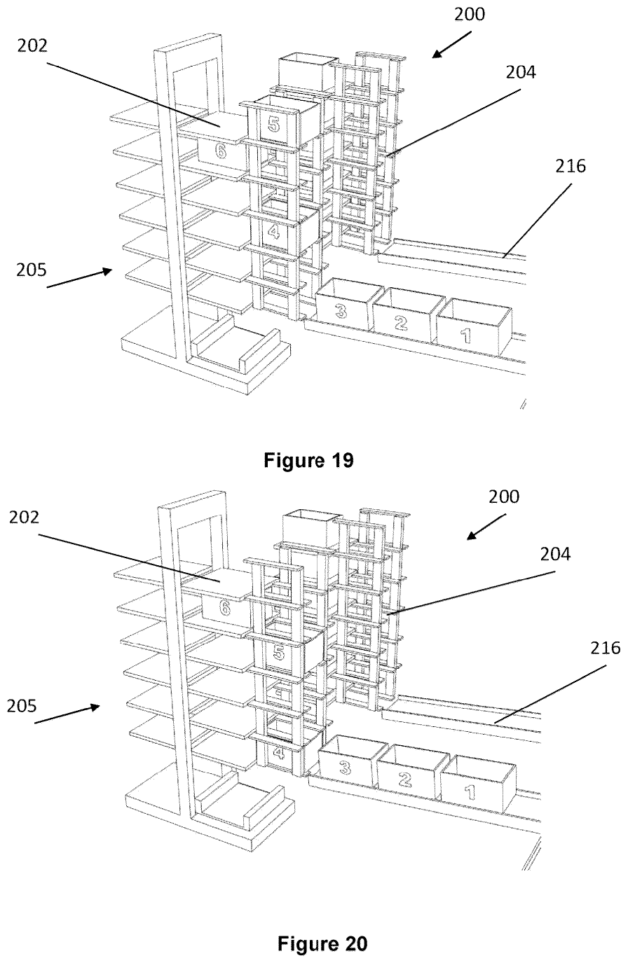

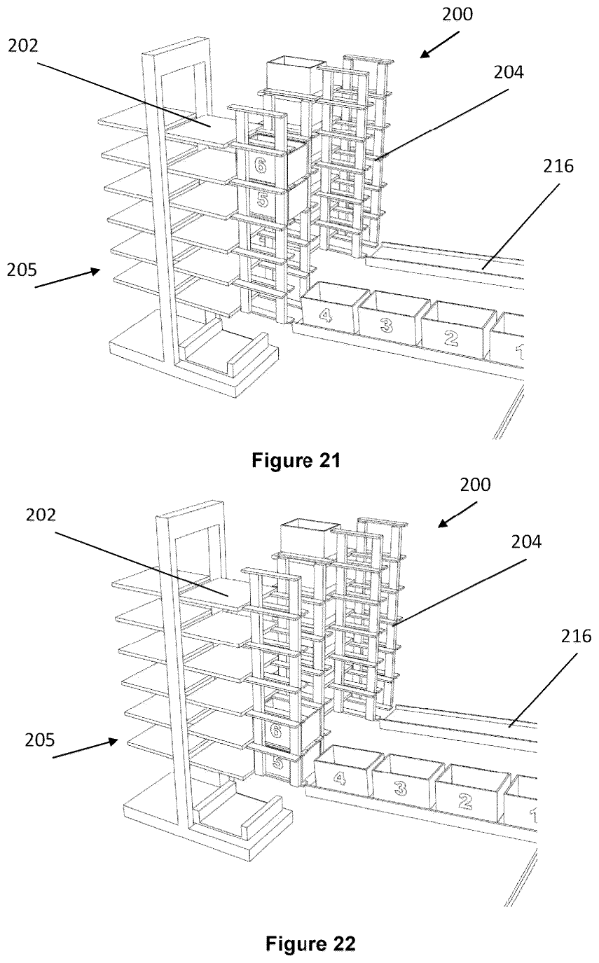

Turning to FIGS. 19 to 21, once the first batch of containers is unloaded onto the horizontal transport means 216, the second batch (containers #4 and #5) is transferred onto the unloading/loading unit 204. containers #4 and #5 are moved down the storage levels of the unloading/loading unit 204 until the third batch (container #6) can be transferred onto the unloading/loading unit 204 (see FIG. 21). Thus, the controller is able to sense and determine which containers are on which shelves of the rack unit 202 and assess which containers need to be transferred onto the unloading/loading unit 204 and in what order so that the containers 10 are transferred away from the destacking device 200 in the predetermined order.

FIGS. 22 to 25 show the remaining containers #5 and #6 being moved down the storage levels and unloaded onto the horizontal transport means 216 as described above. Thus, the destacking device 200 is able to destack and unload containers 10 in a predetermined order before further transportation or handling of the containers at a container receiving station.

The destacking device 200 can function in reverse to load containers 10 onto the rack unit 202 in a predetermined order, regardless of the order in which the containers 10 are delivered by the horizontal transport means 216.

As shown by FIGS. 11 to 25, a warehouse can include multiple destacking devices for added efficiency.

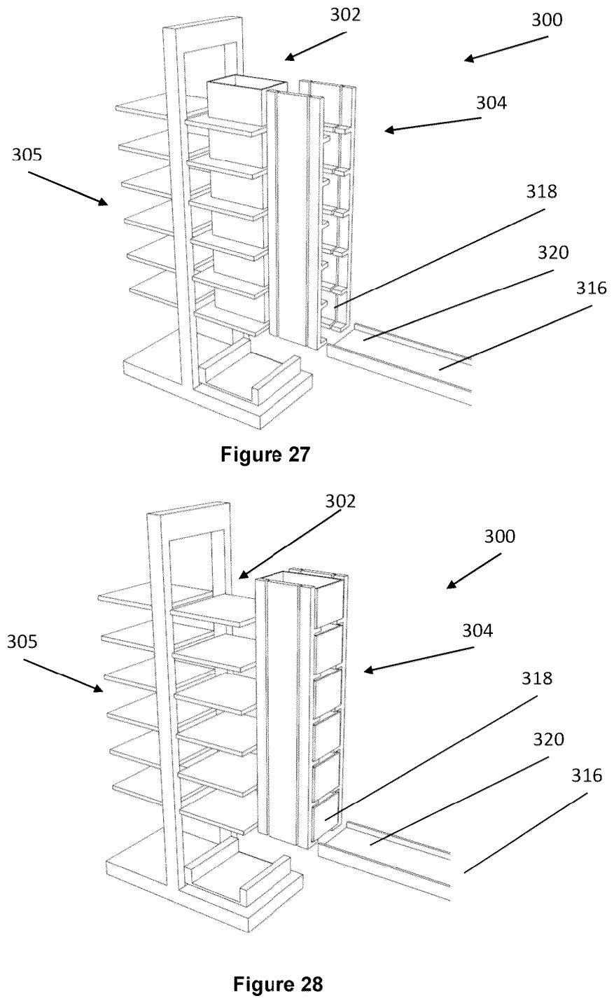

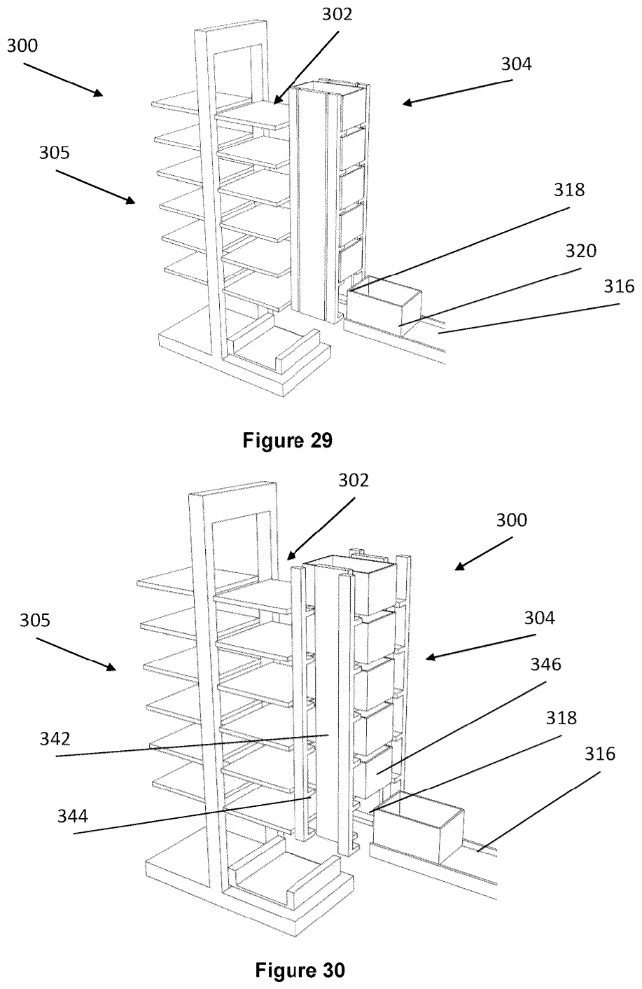

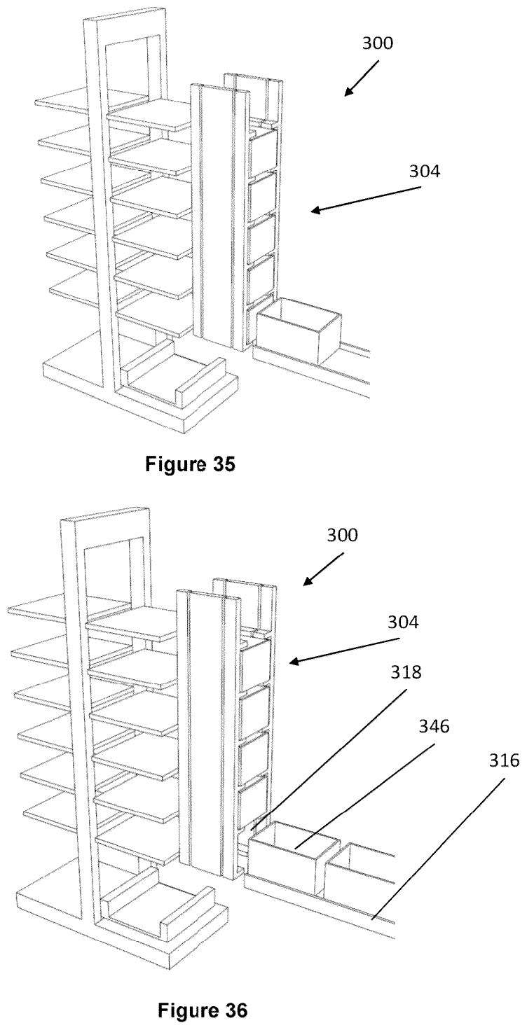

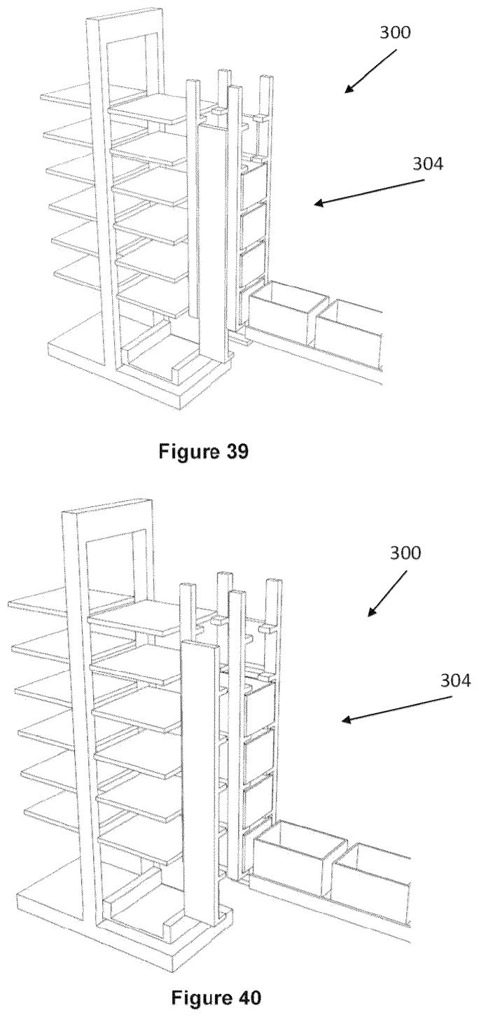

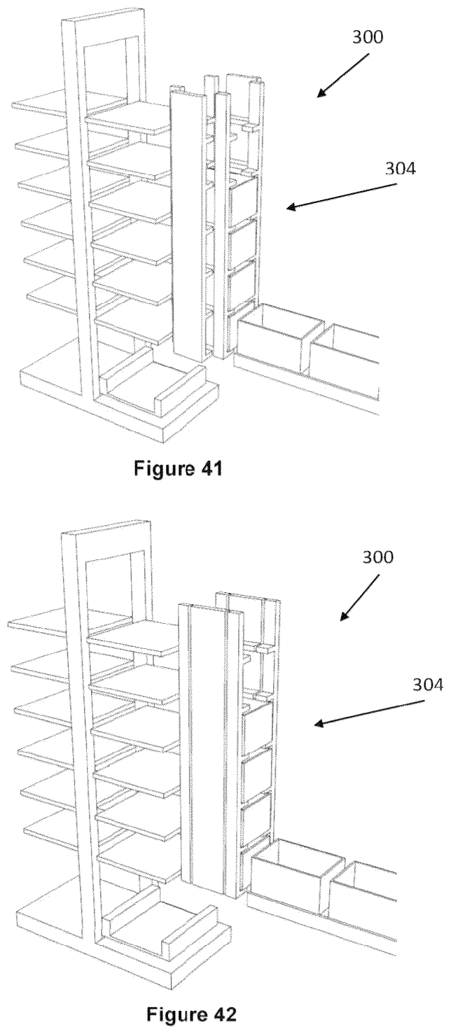

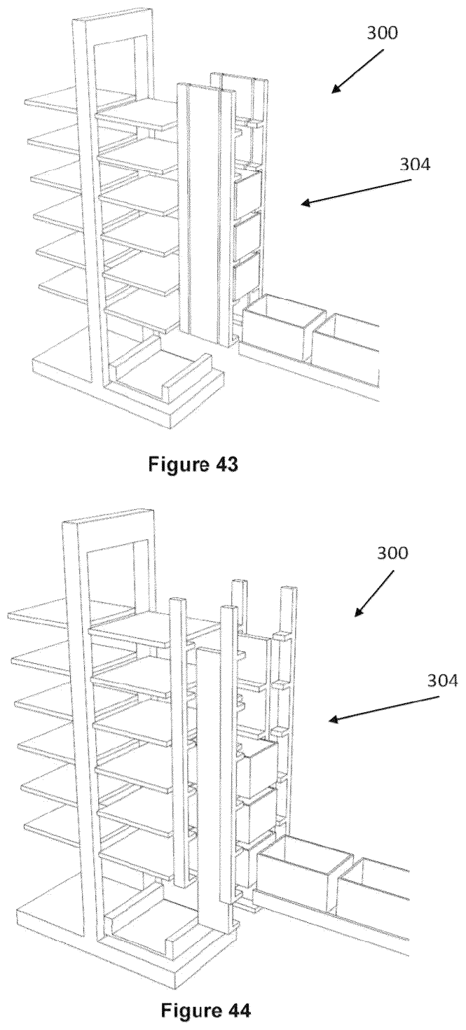

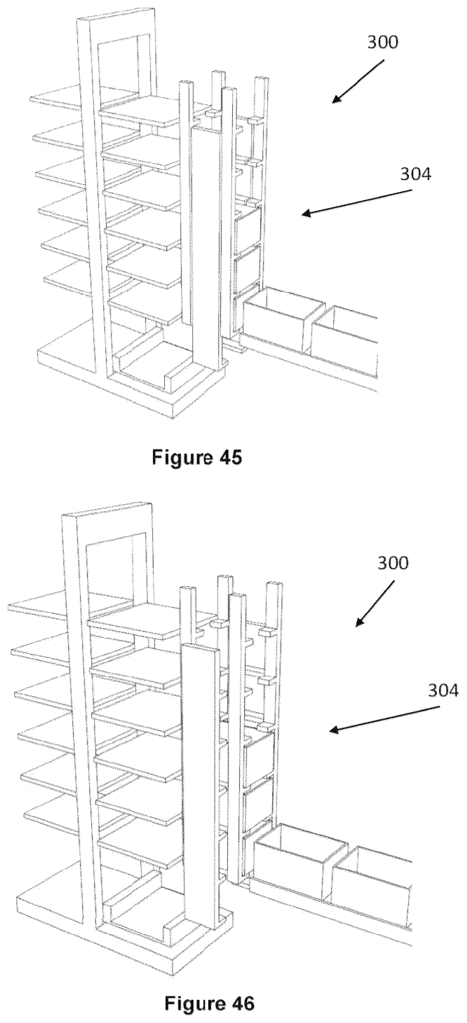

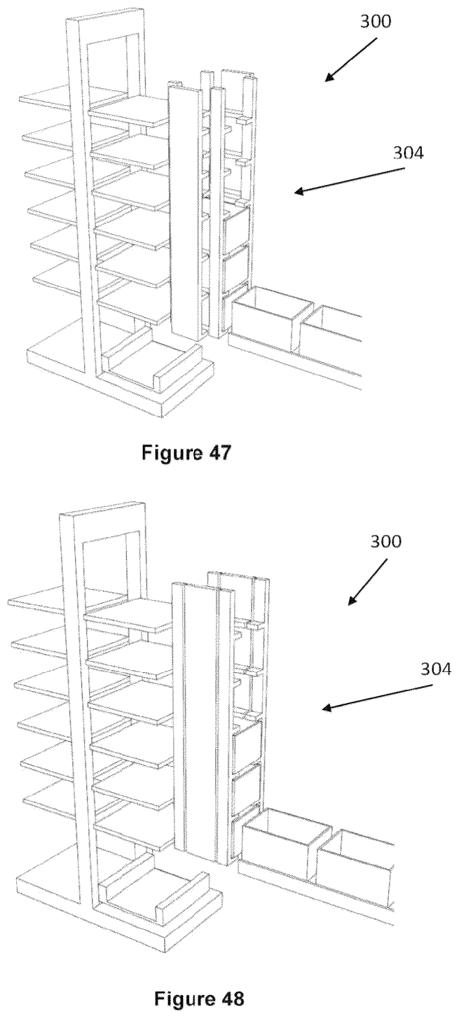

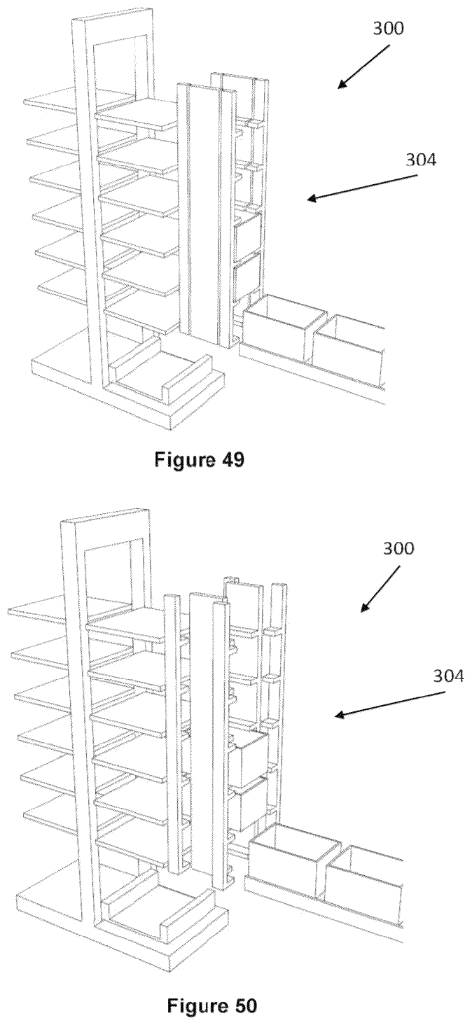

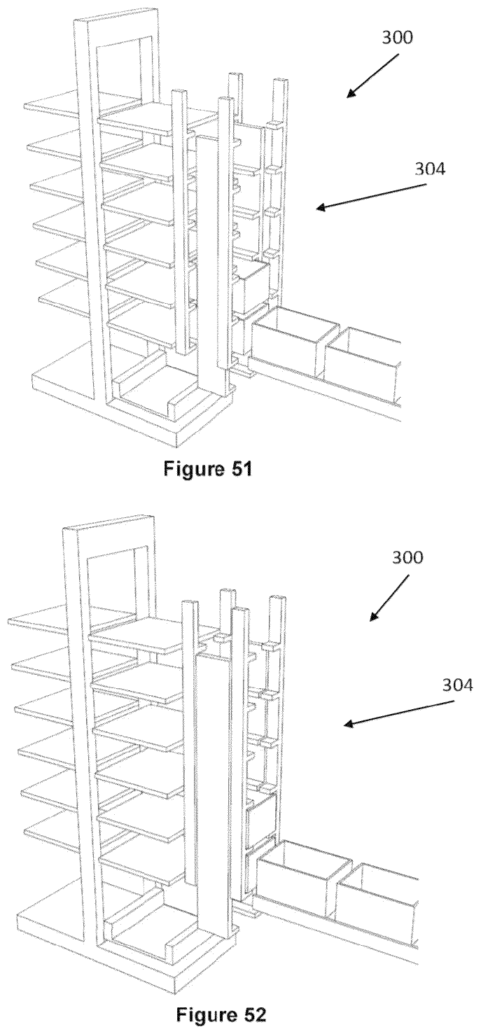

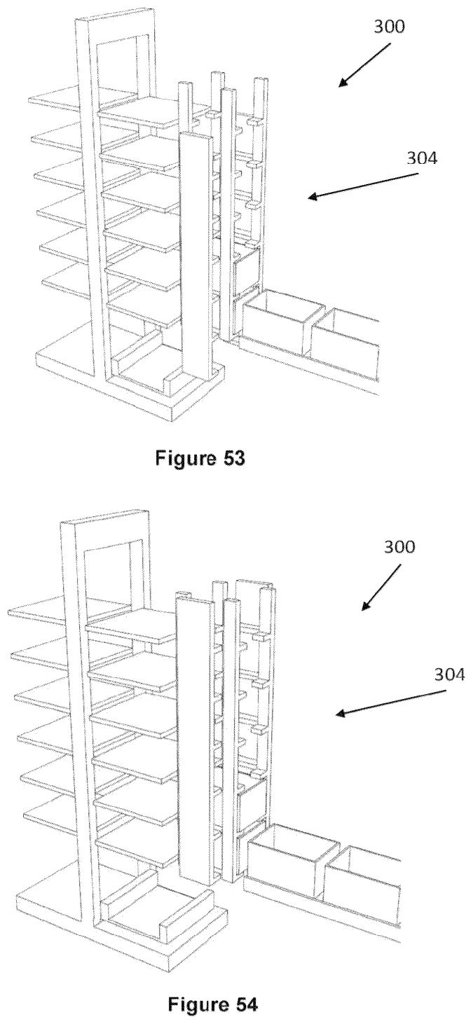

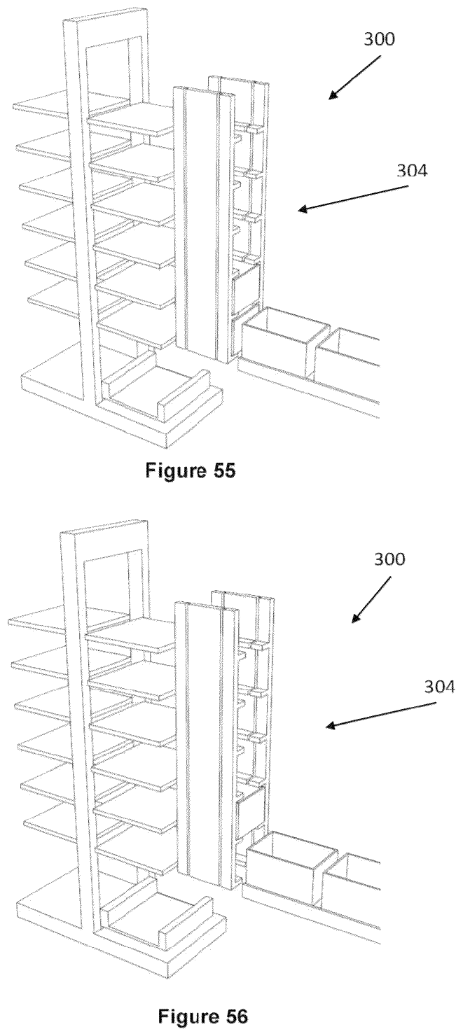

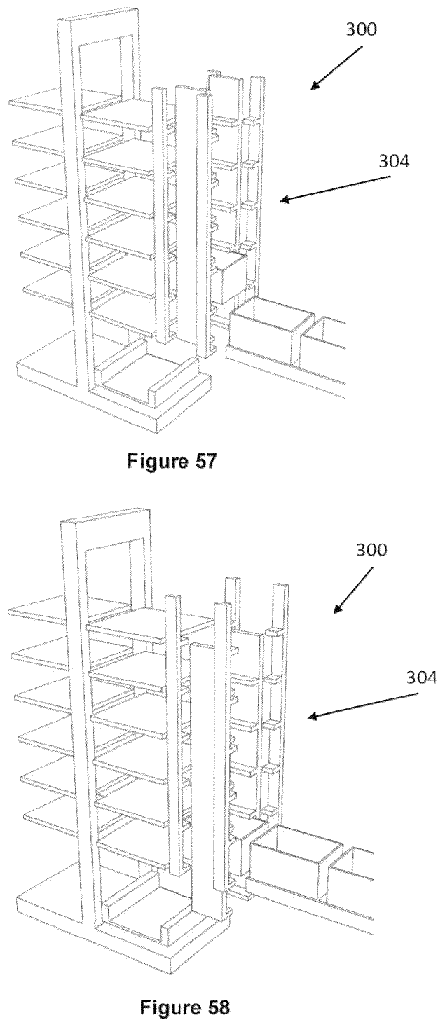

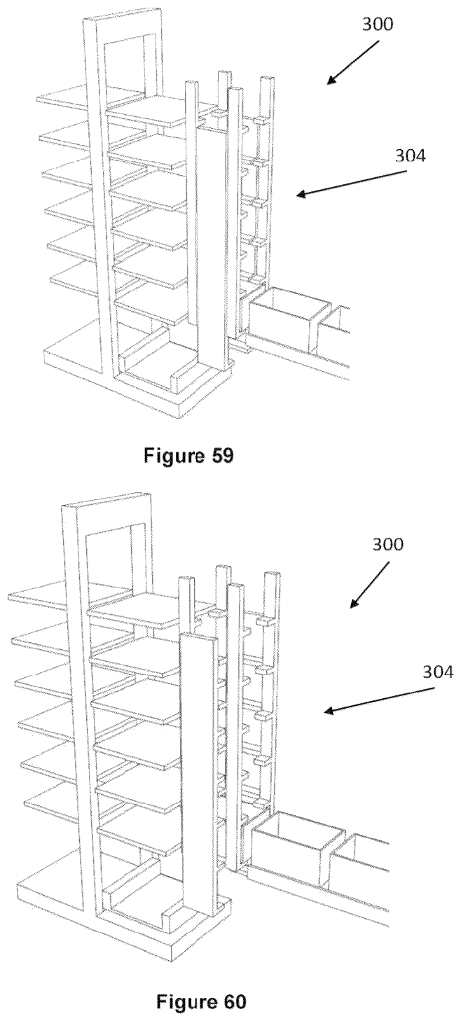

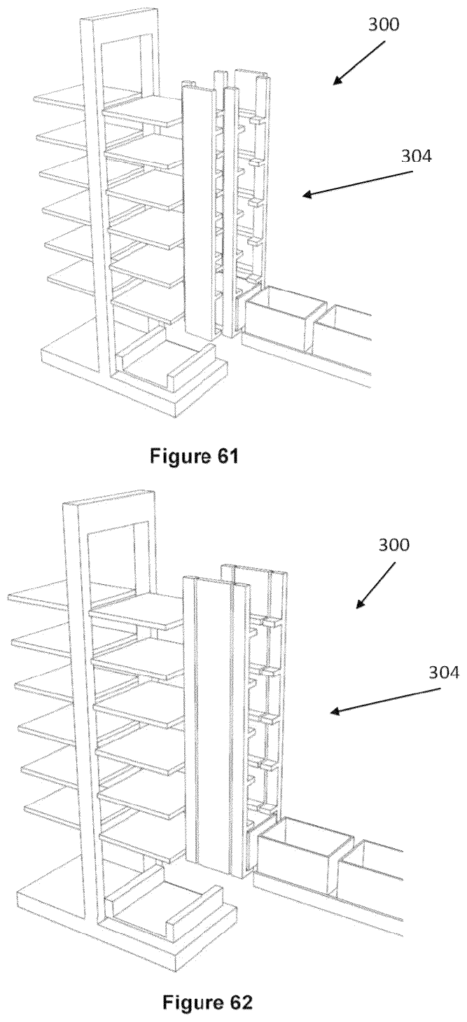

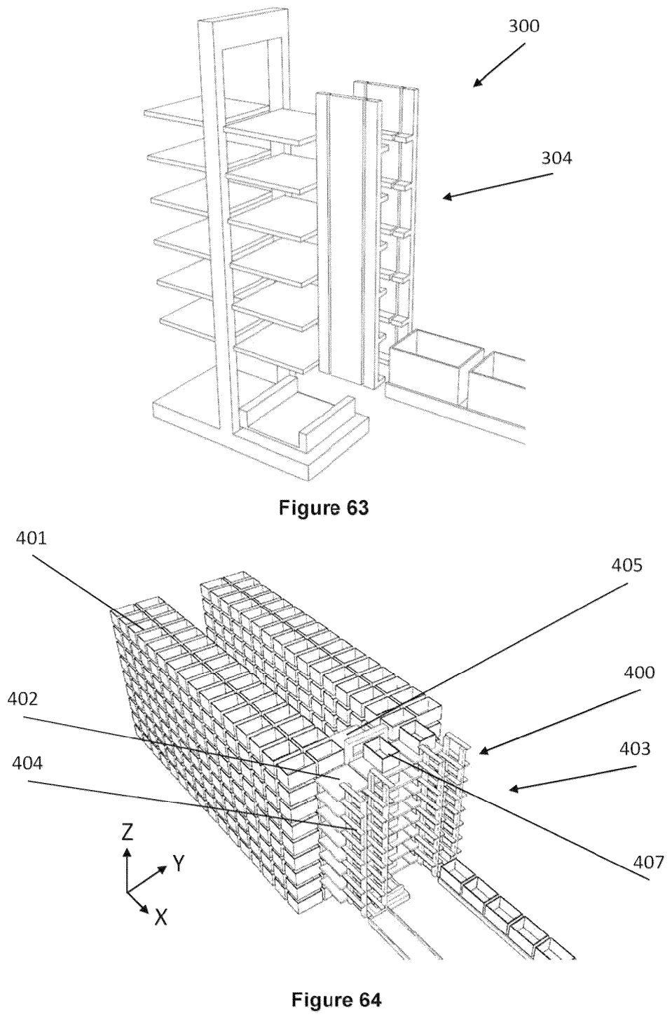

FIGS. 26 to 63 show another embodiment of destacking device 300 as it moves through a sequence of movements to destack or unload containers 10 from a rack unit 302 to a horizontal transport means 316. Turning first to FIGS. 26 to 29, the destacking device 300 includes a rear portion comprising a rack unit 302 as described above and a front portion comprising an unloading/loading unit 304. The destacking device 300 may be approached by an AGV 305 supporting a stack of containers 10, the AGV being instructed to position itself behind the rack unit 302 so that the containers 10 can be transferred from the AGV to the rack unit 302, as described above (see FIG. 27). In other embodiments, the containers 10 may be loaded onto the rack unit 302 directly from a separate rack or manually (i.e. without the need for an AGV). The rack unit 302 transfers the containers 10 onto the unloading/loading unit 304 ready for unloading. The horizontal transport means 316 transfers a container from the lowermost storage level 318 of the unloading/loading unit 304 to the transfer position 320 either by means (e.g. conveyor means) on the horizontal transport means 316 or by means provided by the unloading/loading unit 304 (as described above).

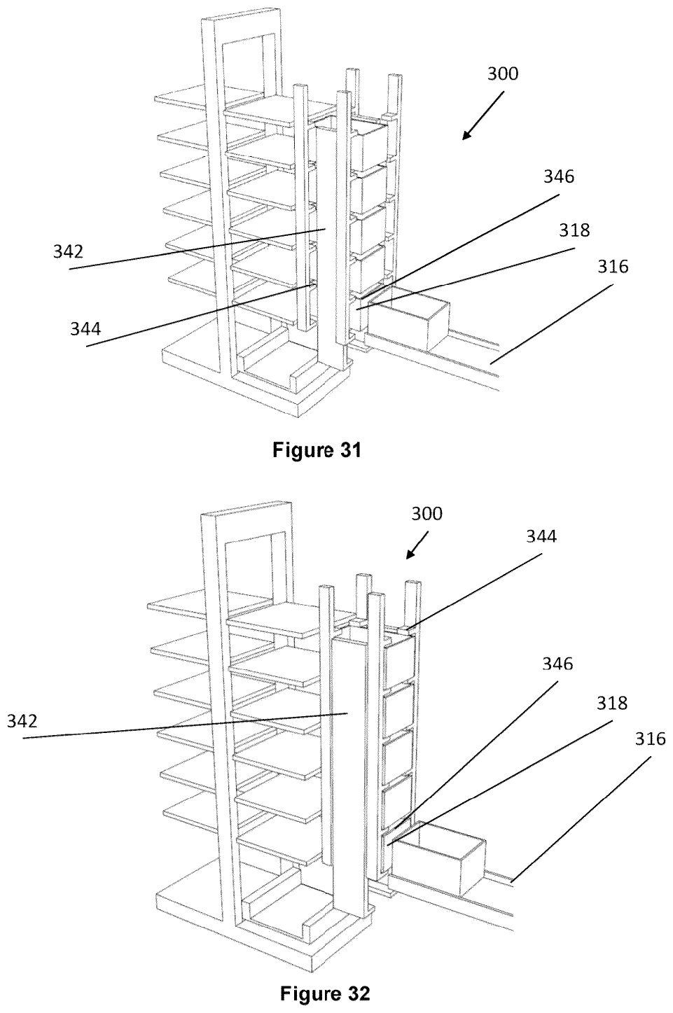

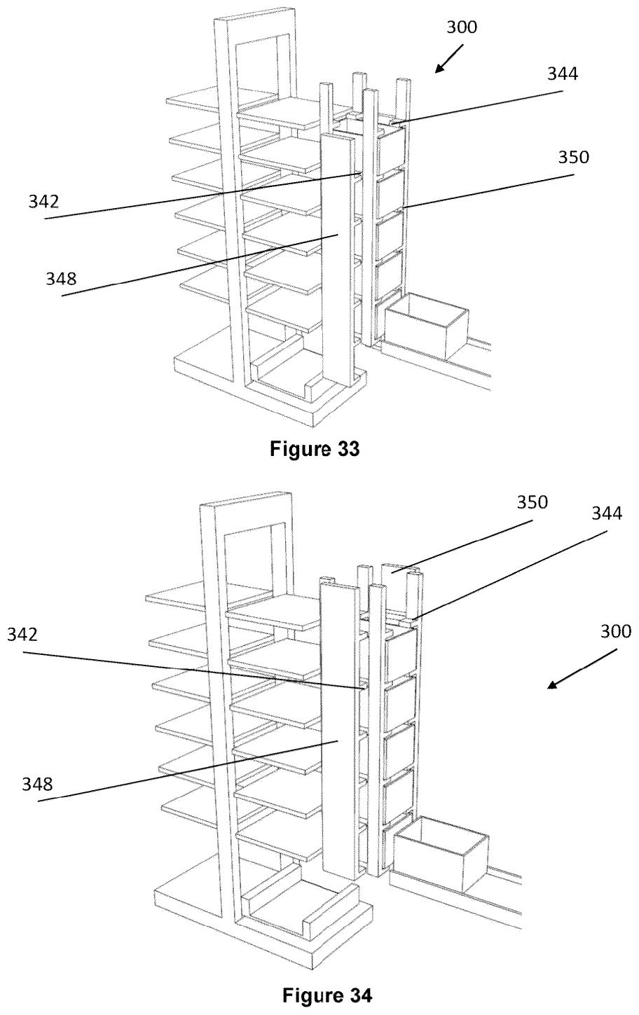

Turning now to FIG. 30, each shelf (i.e. bracket) of the unloading/loading unit 304 includes a shelf portion 342 and a support portion 344. As shown by FIG. 30, the support portions 344 are configured to move laterally outwards from the frame (i.e. laterally outwards from a central longitudinal axis of the vertical frame) such that the support portions 344 no longer support the containers 10. This allows the shelf portions 342 to move downwards, thereby moving the containers 10 down by a storage level so as to bring a second container 346 down to the lowermost storage level 318 (see FIG. 31). Once a second container 346 is in position on the lowermost storage level 318, the support portions 344 move laterally inwards towards the frame so that the support portions 344 support the containers in their respective storage levels (see FIG. 32). This allows the shelf portions 342 to move laterally outwards from the frame and upwards so as to re-align with the support portions 344 before moving back inwards towards the frame and supporting the containers (see FIGS. 33-35). Once the shelf portions 342 and the support portions 344 are in position, the horizontal transport means 316 can transfer the second container 346 at the lowermost storage level 318 to the transfer position 320 (see FIG. 36).

The shelf portions 342 extend from or are mounted to an inner (e.g. central) section 348 of the upright supports and the support portions 344 extend from or are mounted to an outer section 350 of the upright supports (see FIGS. 33-34). In other embodiments this may be reversed. In this way, movement of the inner section 348 of the upright supports (e.g. laterally outwards from the frame, upwards, inwards towards the frame etc.) moves all the shelf portions 342 simultaneously (as shown in FIGS. 33-35) and movement of the outer section 350 of the upright supports (e.g. lateral outwards from the frame, upwards, inwards towards the frame etc.) moves all the support portions 344 simultaneously (as shown in FIGS. 30-32).

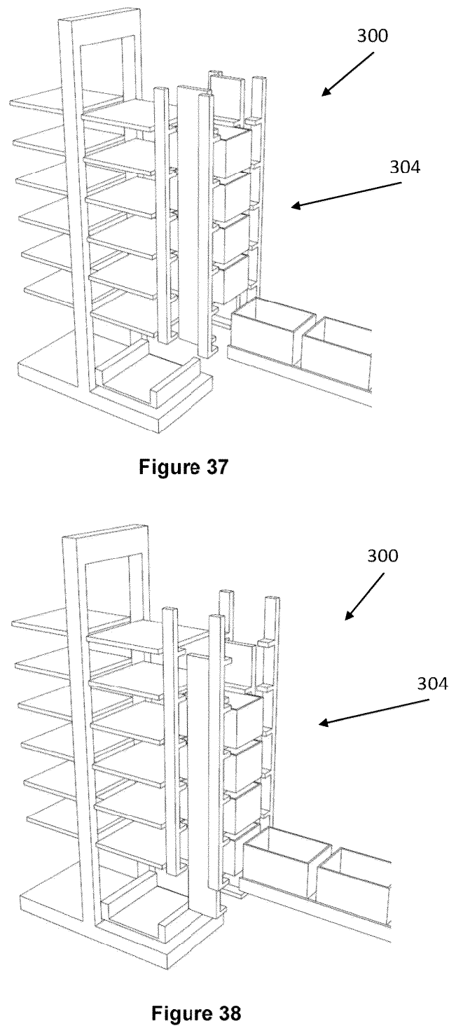

Once the second container 346 is transferred to the transfer position, the outer and inner sections of the upright supports continue the sequence of movements described above to bring down each container in turn to the lowermost storage level 318, allowing each container to be transferred to the horizontal transport means 316 until all the containers have been unloaded from the unloading/loading unit 304 (see FIGS. 37 to 63).

The destacking device 300 of FIGS. 26-63 is configured to function in reverse, in order to transfer containers from the horizontal transport means 316 onto the unloading/loading unit 304, thereby stacking the containers onto the vertical frame. Once the horizontal transport means 316 transfers a first container from the transfer position to the lowermost storage level of the unloading/loading unit 304, the outer and inner sections of the upright supports can carry out the above sequence of movements in reverse, bringing the first container from the lowermost storage level to another storage level (e.g. the second storage level directly above the lowermost storage level) freeing the lowermost storage level for another container to be transferred thereon.

The inner and outer sections of the upright supports may move the shelf portions 342 and the support portions 344 such that the storage levels move up and/or down by more than one storage level. For example, if a storage level is not loaded with a container, the inner and outer sections of the upright supports may continue through the above sequence of movements until a container is brought down to the lowermost storage level for transfer to the horizontal transport means 316. Alternatively, when loading the unloading/loading unit 304, the inner and outer sections of the upright supports may continue through the sequence of movements without loading a container onto the lowermost storage level so as to leave a storage level unloaded.

The rack unit 302 in the destacker device 300 of FIGS. 26-63 may transfer the containers onto the unloading/loading unit 304 individually (i.e. one by one) and/or in batches (i.e. multiple containers simultaneously) as described above in relation to FIGS. 11 to 25, such that the containers may be unloaded from the destacking device 300 in a predetermined sequence.

In the above embodiments, the horizontal transport means is located level with the lowermost storage level of the unloading unit. However, in other embodiments, the horizontal transport means may be located level with any other storage level of the unloading/loading unit, so as to transfer a container from any storage level of the unloading/loading unit to the horizontal transport means.

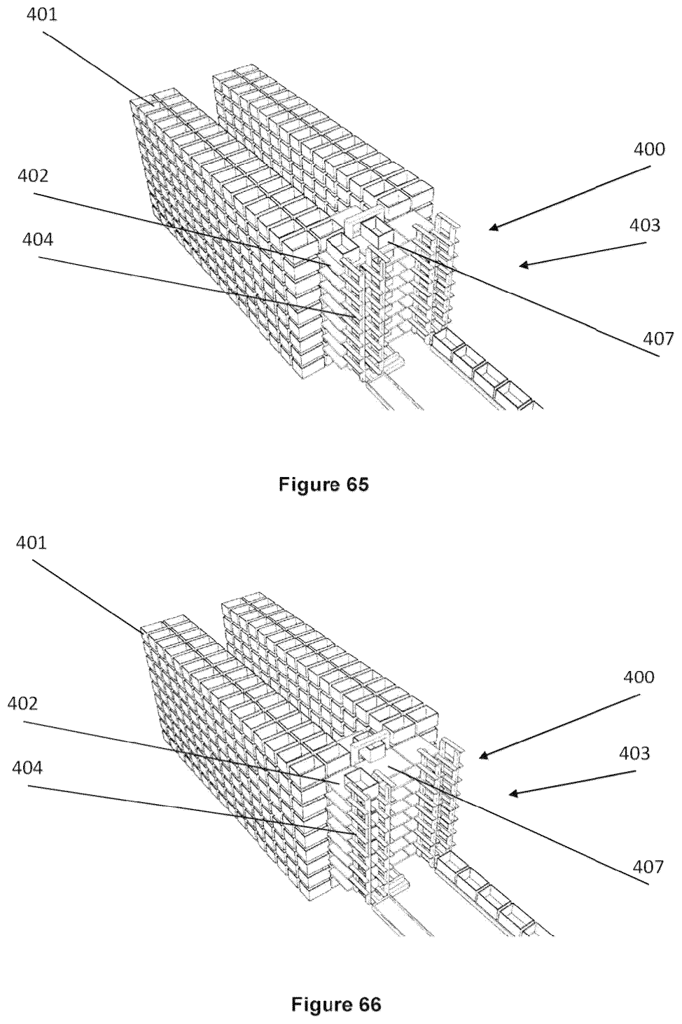

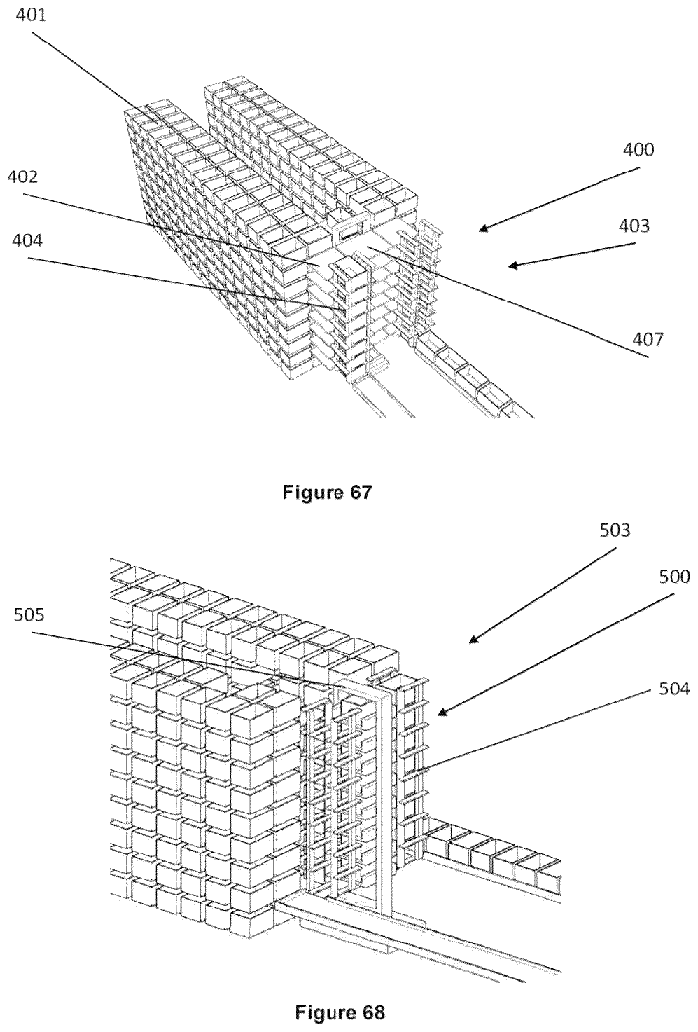

FIGS. 64 to 67 show a warehouse comprising a plurality of rows of shelves 401 supporting containers and an AGV 405 comprising a plurality of shelves for holding containers. The AGV travels across the warehouse floor and between the rows of shelves to collect one or more containers from various locations on the shelves and transports them to a destacking system 403. The destacking system 403 shown in FIGS. 64 to 67 comprises multiple (e.g. two or more) destacking devices 400 and an exchange unit 407 located between the destacking devices. Although FIGS. 64 to 67 illustrate the destacking device of FIGS. 1 to 10, the destacking system may include the destacking devices of any of the above described embodiments. The exchange unit 407 comprises a plurality of shelves configured to support a container on each shelf and located directly adjacent to the rack units of the destacking devices. The exchange unit 407 is configured to receive a stack of containers from an AGV and transfer them across (i.e. laterally in the y direction) to the rack unit 402. Each shelf of the exchange unit 407 includes a conveyor means configured to move the containers in both the x and the y directions, i.e. the shelves of the exchange unit 407 are configured to receive containers from an AGV and transfer containers onto an AGV (i.e. move the containers in the x direction) as well as transfer the containers between the exchange unit 407 and the rack units 402, and vice versa, (i.e. move the containers laterally in the y direction). The shelves of the rack units 402 also include conveyor means configured to move containers in both the x and the y directions, i.e. to receive and transfer containers from/to the exchange unit 407 as well as receive and transfer containers from/to their respective unloading/loading units 404.

As shown by FIGS. 64 to 67, the exchange unit 407 may transfer a first stack of containers to one destacking device (i.e. on one side of the exchange unit) and simultaneously receive a second stack of containers from another destacking device (i.e. from the opposite side of the exchange unit). This set up provides a particular efficient destacking system able to load and unload a large number of containers at any one time.

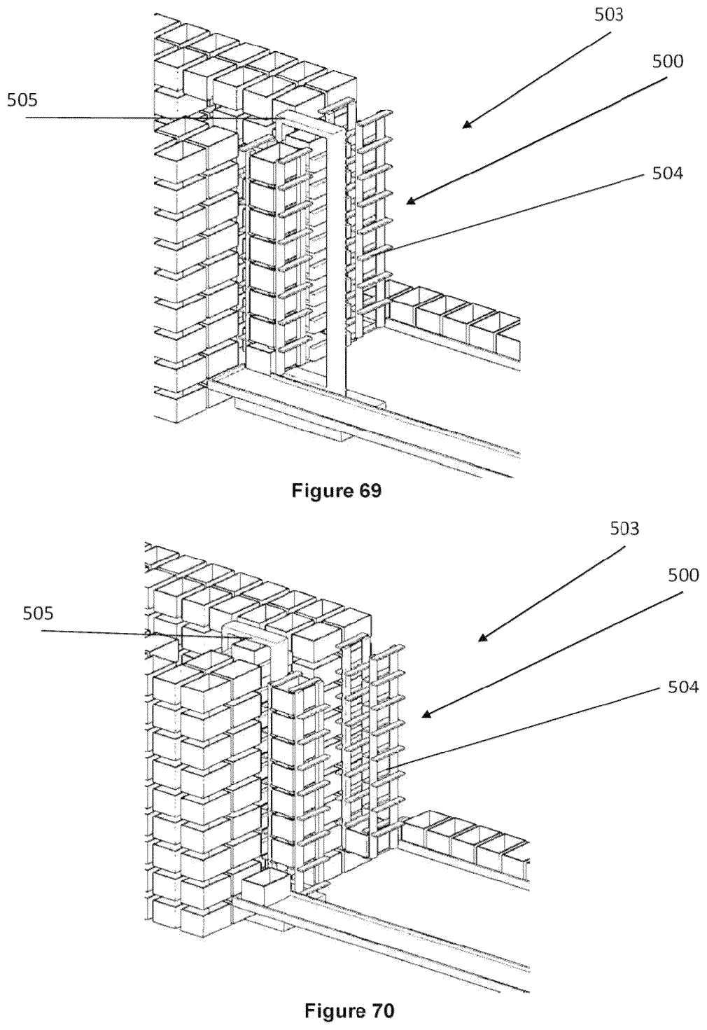

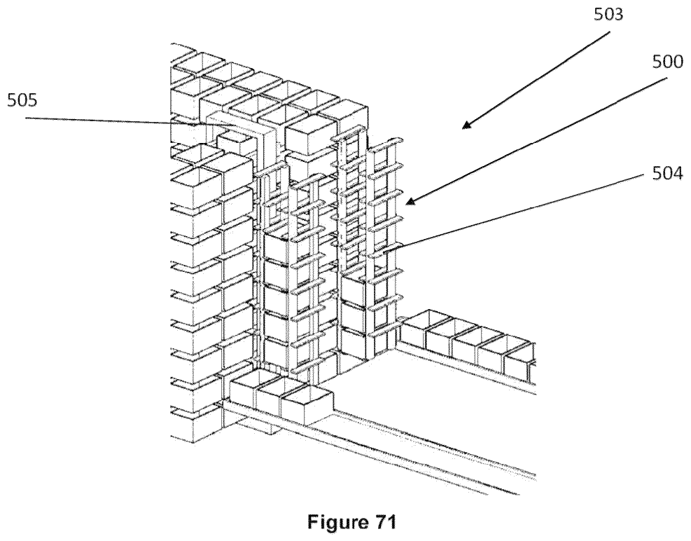

FIGS. 68 to 71 shows another embodiment of destacking system 503 comprising multiple (e.g. two or more) destacking devices 500 each comprising solely the unloading/loading unit 504. An AGV 505 transfers a first stack of containers collected from racks in the warehouse directly onto the unloading/loading unit 504 of a first destacking device while simultaneously receiving a second stack of containers directly from the unloading/loading unit 504 of a second destacking device. The first and second destacking devices are positioned such that an AGV fits accurately between the two destacking devices so as to simultaneously transfer a first stack of containers to the first destacking device (i.e. out from the front of the AGV unit) while receiving a second stack of containers from the second destacking device (i.e. in from the back of the AGV unit).

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

1-18- (canceled)

19. An automatic destacking device for loading and unloading containers from a rack, the destacking device comprising:
an unloading/loading unit which includes:
a vertical frame including a pair of laterally spaced upright supports; and
a plurality of shelves vertically spaced between the upright supports, each shelf being configured to support a container thereon, wherein each shelf provides a storage level for containers such that the shelves provide an array of vertically stacked storage levels for the containers, each shelf being configured to be vertically moveable to a different height position along the vertical frame so as to move a container supported on a shelf up or down the storage levels.

20. An automatic destacking device according to claim 19, wherein the shelves are vertically moveable to different height positions along the vertical frame so as to move a container supported on one of the shelves up or down the storage levels to a predetermined storage level.

21. An automatic destacking device according to claim 20, comprising:
a horizontal transport means located at a position level with the predetermined storage level, the horizontal transport means being configured to transfer containers from the predetermined storage level to a transfer position on the horizontal transport means.

22. An automatic destacking device according to claim 21, wherein the automatic destacking device is configured to function in reverse to transfer containers from the transfer position to the predetermined storage level of the unloading/loading unit.

23. An automatic destacking device according to any one of claim 21, wherein the horizontal transport means comprises:
a conveyor means.

24. An automatic destacking device according to claim 20, wherein the shelves are configured to be vertically moveable to a different height position so as to move a container at the predetermined storage level to a different storage level of the unloading/loading unit.

25. An automatic destacking device according to any one of claim 20, wherein the predetermined storage level is a lowermost level of the vertically stacked storage levels.

26. An automatic destacking device according to claim 19, comprising:
a drive means for moving the shelves to different height positions along the frame.

27. An automatic destacking device according to claim 19, wherein each shelf comprises:
a pair of opposing horizontal support members extending inwards from the upright supports.

28. An automatic destacking device according to claim 27, wherein each pair of support members comprises:
a first support member coupled to a first upright support and a second support member coupled to a second upright support, the first upright support providing a guide member for guiding movement of the first support members and the second upright support providing a guide member for guiding movement of the second support members, wherein the first support members rotate around the first upright support in a vertical loop and the second support members rotate around the second upright support in a vertical loop.

29. An automatic destacking device according to claim 28, wherein a drive means is configured to move the first support members up or down the frame synchronously with the second support members, thereby keeping the first and second support members from each pair of support members oppositely facing as they move up and down the vertical frame.

30. An automatic destacking device according to claim 27, wherein each support member comprises:
a shelf portion and a support portion, wherein the support portions are configured to move laterally outwards, and wherein the shelf portions are configured to move vertically relative to the support portions, to thereby move the containers up or down the storage levels.

31. An automatic destacking device according to claim 30, wherein the shelf portions are mounted to an inner section of the upright supports, and wherein the support portions are mounted to an outer section of the upright supports.

32. An automatic destacking device according to claim 19, comprising:
a rack unit including a plurality of shelves configured to support a container on each shelf, the rack unit being located to a rear of the unloading/loading unit and being configured to transfer containers from the shelves of the rack unit to the shelves of the unloading/loading unit.

33. An automatic destacking device according to claim 32, wherein the shelves of the rack unit comprise:
conveyor means for transferring containers from the rack unit to the shelves of the unloading/loading unit.

34. An automatic destacking device according to claim 32, wherein the destacking device is configured to transfer containers from the rack unit to the unloading/loading unit in a predetermined order.

35. An automatic destacking device according to claim 32, wherein the destacking device is configured to transfer containers from the rack unit to the vertical frame in batches.

36. An automatic destacking system according to claim 19, for loading and unloading containers from a rack, the destacking system comprising:
at least two destacking devices according to claim 19; and
an exchange unit located between the at least two destacking devices, the exchange unit including a plurality of shelves configured to support a container on each shelf, the exchange unit being configured to transfer a first stack of containers to a first of the at least two destacking devices and simultaneously receive a second stack of containers from a second of the at least two destacking devices.
